(19) United States
(12) Patent Application Publication
(10) Pub. No.: US 2016/0238902 A1
(43) Pub. Date: Aug. 18, 2016

(54) LIQUID CRYSTAL DISPLAY DEVICE

(71) Applicant: Japan Display Inc., Tokyo (JP)

(72) Inventors: Satoru KAWASAKI, Tokyo (JP); Kimitoshi Ohgiichi, Tokyo (JP); Saori Gugiyama, Tokyo (JP)

(21) Appl. No.: 15/040,581

(22) Filed: Feb. 10, 2016

(30) Foreign Application Priority Data
Feb. 12, 2015 (JP) 2015-025210

(51) Int. Cl. G02F 1/1343; G02F 1/1335; G02F 1/1337; G02F 1/1368

(52) U.S. Cl. CPC G02F 1/134309; G02F 1/1368; G02F 1/133512; G02F 1/1337

(57) ABSTRACT

In an IPS system liquid crystal display device, scan lines are extended in a first direction and arrayed in a second direction, video signal lines are extended in the second direction and arrayed in the first direction, an orientation axis of an orientation film is oriented in the second direction, the pixel electrode includes a first region including a through-hole for supplying a video signal and second and third regions through which light is transmitted, the second region is inclined at an angle η, the third region is inclined at an angle −η, each of the second region and the third region is bent at a bending point so as to protrude in the first direction, a protruded part and a recessed part are formed in the vicinity of a boundary between the first and second regions.

### CLAIM OF PRIORITY

The present application claims priority from Japanese Patent Application JP 2015-025210 filed on Feb. 12, 2015, the content of which is hereby incorporated by reference into this application.

### BACKGROUND OF THE INVENTION

(1) Field of the Invention

The present invention relates to a liquid crystal display device and, in particular, relates to the liquid crystal display device making it possible to prevent generation of a domain caused by reverse rotation of liquid crystal molecules caused by a pressing pressure (pressurization) imposed on a liquid crystal display panel.

(2) Description of the Related Art

The liquid crystal display device includes the liquid crystal display panel which includes a TFT substrate on which pixels which each includes a pixel electrode, a thin film transistor (TFT) and so forth are formed in a matrix, a counter substrate which faces the TFT substrate, a liquid crystal layer which is held between the TFT substrate and the counter substrate and so forth. Then, an image is formed by controlling a transmittance of the liquid crystal molecules through which light is transmitted per pixel.

In the liquid crystal display device, a viewing angle plays an important role. An IPS (In Plane Switching) system liquid crystal display device is configured to control the transmittance of the liquid crystal layer by rotating the liquid crystal molecules by a horizontal electric field and has excellent viewing angle characteristics. On the other hand, a system that a touch panel through which coordinates and so forth are input by touching the panel with a finger and so forth is integrated with the liquid crystal display device is now being generally used.

When the liquid crystal display panel has been depressed with the finger and so forth, an orientation direction of the liquid crystal molecules may be changed and may induce generation of disclination. Non-uniformity caused by this disclination is called “depressing non-uniformity’. The pixel electrode which has taken measures against the depressing non-uniformity in the IPS system liquid crystal display device is described in Japanese Unexamined Patent Application Publication No. 2010-9004

### SUMMARY OF THE INVENTION

Although the IPS system liquid crystal display device has the excellent viewing angle characteristics, when the liquid crystal molecules which are driven by an electric field generated between the pixel electrode and a common electrode all rotate in the same direction relative to an initial orientation direction defined by an orientation film, brightness and colors of the respective liquid crystal molecules are made different from one another depending on an azimuth taken. In order to avoid the above-mentioned situation, such a configuration is conceivable that the pixel electrode or the common electrode is bent in the same pixel so as to make a direction of the electric field different from the initial orientation direction of the liquid crystal molecules in the same pixel and thereby the orientation (rotation) directions of the liquid crystals are made different from one another.

This configuration is called a multi-domain system because the plurality of domains are present in one pixel. In the multi-domain system, for example, an upper half and a lower half of one pixel are different from each other in orientation (rotation) direction of the liquid crystal molecules when a voltage has been applied between the pixel electrode and the common electrode.

In the multi-domain system, a phenomenon that depression domains which are generated when the counter substrate has been depressed mutually interact in the upper half and the lower half of the pixel and the depression domains remain as they are over a long period of time occurs.

The present invention has been made in view of the above-mentioned circumstances and aims to take measures against screen non-uniformity caused by long-term presence of the depression domains.

In order to overcome the above-mentioned disadvantage, the present invention takes concrete measures as follows.

According to one embodiment of the present invention, there is provided a liquid crystal display device which includes a TFT substrate that scan lines are extended in a first direction and are arrayed in a second direction, video signal lines are extended in the second direction and are arrayed in the first direction, a pixel electrode is formed in a region surrounded by the scan lines and the video signal lines and a common electrode is formed via an insulation film, a counter substrate which is arranged so as to face the TFT substrate and a liquid crystal layer which is held between the TFT substrate and the counter substrate, in which the pixel electrode is extended in the second direction and includes a first side face on the side of the first direction, the pixel electrode includes a first region which includes a through-hole through which a video signal is supplied and second and third regions through which light is transmitted, the second region is inclined at an angle η relative to the second direction and the third region is inclined at an angle −η relative to the second direction, each of the second region and the third region is bent at a bending point so as to protrude in the first direction, the second region is bent in a direction opposite to the first direction in the vicinity of the first region to form a recessed part in the first side surface of the pixel electrode, the recessed part includes an upper side and a lower side, a protruded part which is extended in the first direction is included in the first region in the second direction relative to the recessed part and the lower side of the recessed part forms part of an upper side of the protruded part, an angle θ1 of the upper side of the protruded part relative to the second direction is not more than about 90° and at least about 45° and an angle θ2 of the upper side of the recessed part relative to the second direction is not more than the angle θ1.

In the above-mentioned liquid crystal display device, the lower side of the protruded part includes a corner cut and an angle θ3 of the corner cut relative to the second direction is not more than the angle θ1.

### BRIEF DESCRIPTION OF THE DRAWINGS

FIG. 1 is a sectional diagram illustrating one example of a liquid crystal display device to which one embodiment of the present invention is applied.

FIG. 2 is a plan view illustrating one example of a pixel part according to one embodiment of the present invention.

FIG. 3 is a plan view illustrating one example of initial orientation of liquid crystal molecules according to one embodiment of the present invention.

FIG. 4 is a plan view illustrating one example of orientation of the liquid crystal molecules when a voltage has been applied to a pixel electrode.

FIG. 5 is a plan view illustrating one example of orientation disturbance of the liquid crystal molecules when one point of a counter substrate has been pressurized.

FIG. 6 is a plan view illustrating one example of disturbance of the liquid crystal molecules after pressurization has been released in a pixel electrode to which the present invention is not applied.

FIG. 7 is a plan view illustrating one example of orientation of the liquid crystal molecules after pressurization has been released in the pixel electrode according to one embodiment of the present invention.

FIG. 8 is a detailed plan view illustrating one example of the pixel electrode according to one embodiment of the present invention.

### DETAILED DESCRIPTION OF THE PREFERRED EMBODIMENT

Although there exist various types of IPS systems, since the IPS system of the type that, for example, a common electrode is planarly formed, a comb-shaped (linear) pixel electrode is arranged on the common electrode with an insulation film being interposed between the common electrode and the pixel electrode and the liquid crystal molecules are oriented (rotated) by an electric field generated between the pixel electrode and the common electrode makes it possible to increase the transmittance comparatively, the system of the above-mentioned type is mainly used currently.

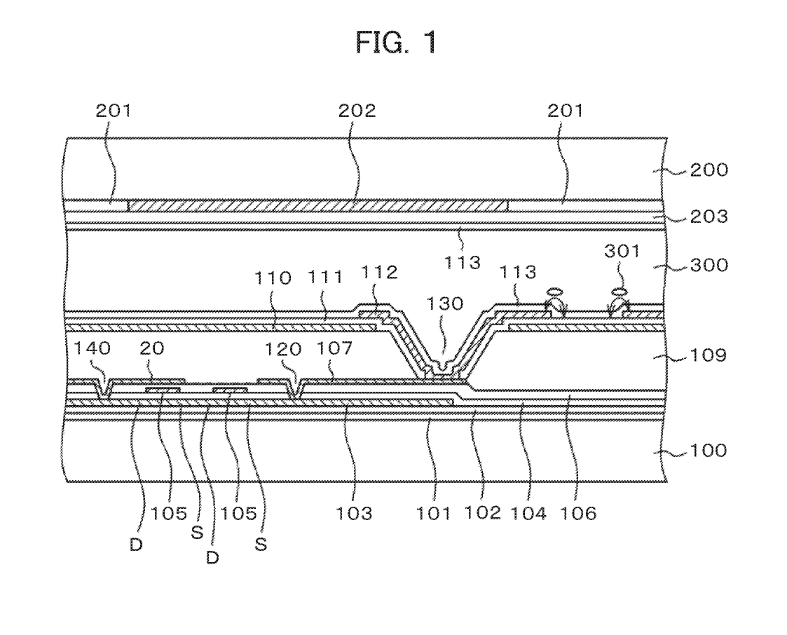

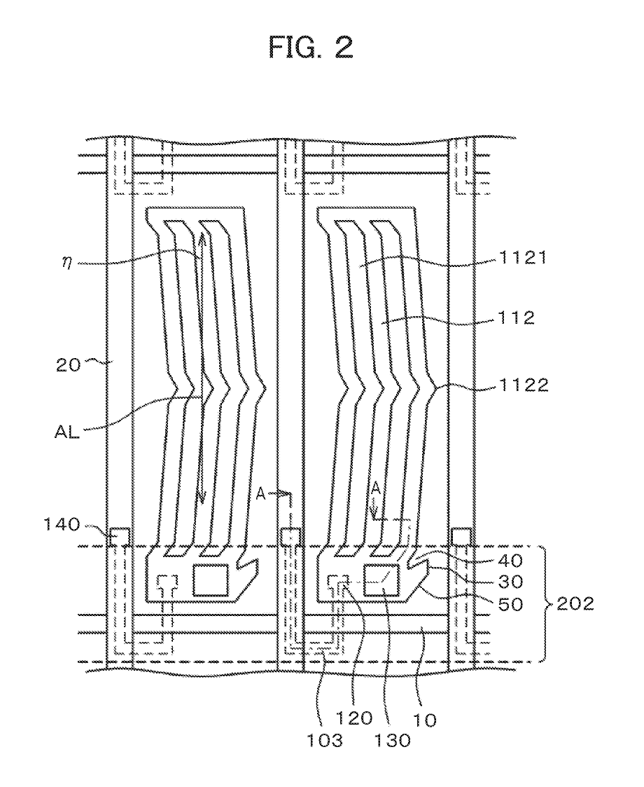

FIG. 1 is a sectional diagram illustrating one example of a liquid crystal display panel of the IPS system as mentioned above. FIG. 1 is a sectional diagram taken along the A-A line in FIG. 2 which will be described later. A TFT (Thin Film Transistor) illustrated in FIG. 1 is a so called top-gate type TFT and as one example of a semiconductor used therein, an LTPS (Low Temperature Poly-Silicon) may be adopted. On the other hand, when an a-Si (amorphous silicon) semiconductor and some LTPSs have been used, a so-called bottom-gate type TFT is frequently used. Although, in the following, description will be made by taking a case where the top-gate system TFT has been used by way of example, it is also possible to apply the present invention to a case where the bottom-gate type TFT has been used.

In the example in FIG. 1, a first base film 101 made of silicon nitride and so forth and a second base film 102 made of silicon oxide (SiO₂) and so forth are formed on a TFT substrate 100 made of glass, resin and so forth by a CVD (Chemical Vapor Deposition) method. The role of the first base film 101 and the second base film 102 is to prevent a semiconductor layer 103 from being stained with impurities generated from the TFT substrate 100.

The semiconductor layer 103 is formed on the second base film 102. The semiconductor layer 103 is of the type that the a-Si film is formed on the second base film 102 by the CVD method and the a-Si film is converted into a poly-silicon (poly-Si) film by performing laser-annealing on the a-Si film. An island-like semiconductor film is formed by patterning the poly-Si film by photolithography.

A gate insulation film 104 is formed on the semiconductor film 103. The gate insulation film 104 is a silicon oxide film made of, for example, TEOS (tetraethoxysilane). Also the gate insulation film 104 is formed by the CVD method. A gate electrode 105 is formed on the gate insulation film 104. A scan line 10 also serves as the gate electrode 105. The gate electrode 105 is formed by high-melting pint metals such as, for example, molybdenum-tungsten (MoW) and so forth, an alloy of these metals and so forth. When the resistance of the gate electrode 105 or the scan line 10 is to be reduced, a laminated film made of a low-resistance metal such as, for example, aluminum (Al), copper (Cu) and so forth and any one of the above-mentioned high-melting point metals.

As illustrated in FIG. 2 which will be described later, since the semiconductor layer 103 passes under the scan line 10 two times, the semiconductor layer 1103 has a double gate structure. Then, an interlayer insulation film 106 is formed by, for example, the silicon nitride and the silicon oxide so as to cover the gate electrode 105. The interlayer insulation film 106 is adapted to insulate between the gate electrode 105 and a contact electrode 107.

A through-hole 120 adapted to connect a source part S of the semiconductor layer 103 with the contact electrode 107 and a through-hole 140 adapted to connect a drain part D of the semiconductor layer 103 with a video signal line 20 are formed in the interlayer insulation film 106 and the gate insulation film 104. Photolithography for forming the through-holes 120 and 140 in the interlayer insulation film 106 and the gate insulation film 104 is simultaneously performed on the interlayer insulation film 106 and the gate insulation film 104. Incidentally, the source part S and the drain part D of the TFT are mutually interchanged appropriately depending on the voltage applied to the TFT.

The contact electrode 107 is formed on the interlayer insulation film 106. The contact electrode 107 is connected with a pixel electrode 112 via a through-hole 130. The contact electrode 107 and the video signal line 20 are simultaneously formed in the same layer. In order to reduce the resistance, for example, Al and an Al alloy are used for the contact electrode 107 and the video signal line 20. Since Al and the Al alloy generate hillocks and Al diffuses to other layers, a structure that Al and the Al alloy are sandwiched between a barrier layer and a cap layer made of the high-melting point metals such as, for example, not illustrated MoW and so forth is adopted. There are cases where part of the video signal line 20 which is connected to the drain part D is called a drain electrode and the contact electrode 107 is called a source electrode.

The entire of the TFT is protected by forming an organic passivation film (an insulation film) 109 so as to cover the contact electrode 107. The organic passivation film 109 is formed with a photosensitive acrylic resin and so forth. It is also possible to form the organic passivation film 109 with resins such as a silicone resin, an epoxy resin, a polyimide resin and so forth other than the acrylic resin. Since the organic passivation film 109 has a role to serve as a flattened film, the organic passivation film 109 is formed thick. Although a film thickness of the organic passivation film 109 may be about 1 μm to about 4 μm, the organic passivation film 109 has the film thickness of about 2 μm to about 3 μm in many cases.

In order to electrically conduct the pixel electrode 112 with the contact electrode 107, the through-hole 130 is formed in the organic passivation film 109. Since the organic passivation film 109 is formed by using the photosensitive resin, when the photosensitive resin is applied and then is exposed to light, only part which has been irradiated with light dissolves in a specific developing agent. That is, it is possible to omit formation of a photoresist film by using the photosensitive resin. After the through-hole 130 has been formed in the photosensitive resin, the resin is baked at about 230° C. and thereby formation of the organic passivation film 109 is completed.

Then, an ITO (Indium Tin Oxide) film which will serve as a common electrode 110 is formed by sputtering and patterning is performed so as to remove the ITO film from within the through-hole 130 and from its surroundings. It is possible to form the common electrode 110 planarly in common among respective pixels. Then, a silicon nitride film which will serve as a capacitance insulation film 111 is formed on the entire surface of the common electrode 110 by the CVD method. Then, a through-hole adapted to electrically conduct the contact electrode 107 with the pixel electrode 112 in the through-hole 130 is formed in the capacitance insulation film 111.

Then, the ITO film is formed by sputtering and the pixel electrode 112 is formed by patterning. An orientation film material is applied onto the pixel electrode 112 by flexography, inkjet printing and so forth and is baked to form an orientation film 113. A photo-orientation method to be performed by using polarized ultraviolet rays is used in orientation processing of the orientation film 113 in addition to a rubbing method.

When a voltage is applied between the pixel electrode 112 and the common electrode 110, such a line of electric force as illustrated in FIG. 1 is generated. A liquid crystal molecule 301 is rotated by an electric field generated by the line of electric force, an amount of light which passes through a liquid crystal layer 300 is controlled per pixel and thereby an image is formed.

In the example in FIG. 1, a counter substrate 200 is arranged with the liquid crystal layer 300 being interposed between the TFT substrate 100 and the counter substrate 200. A color filter 20 is formed on the liquid crystal layer side of the counter substrate 200. As the color filters 201, red, green and blue color filters are formed per pixel and a color image is formed by using these color filters 201. A shading film (a black matrix) 202 is formed between the color filers 201 to as to improve the contract of the image. Incidentally, the shading film 202 also has a role of shading the TFT and prevents a photocurrent from flowing into the TFT.

An overcoat layer 203 is formed so as to cover the color filters 201 and the black matrix 202. Since the surfaces of the color filters 201 and the black matrix 202 are uneven, the surfaces of the color filters 201 and the black matrix 202 are flattened by the overcoat film 203. The orientation film 113 adapted to determine the initial orientation of the liquid crystal molecules is formed on (the liquid crystal layer 300 side) the overcoat film 203. In the orientation processing to be performed on the orientation film 113, the rubbing method or the photo-orientation method is used as in the case of formation of the orientation film 113 on the TFT substrate 100 side.

Incidentally, the above-mentioned configuration is merely one example and there are cases where an inorganic passivation film is formed between the contact electrode 107 and the organic passivation film 109 depending on the kind of device used. In addition, there are also cases where a formation process of the through-hole 130 which is different from the above-mentioned formation process is used depending on the kind of device used. In the following, the present invention will be described in detail by using a preferred embodiment.

### Embodiment 1

FIG. 2 is a plan view illustrating one example of a pixel part according to the embodiment 1 of the present invention. The above-mentioned FIG. 1 is a sectional diagram taken along the A-A line in FIG. 2. In the example in FIG. 2, the scan lines 10 are extended in a horizontal direction and are arrayed in a vertical direction. In addition, the video signal lines 20 are extended in the vertical direction and are arrayed in the horizontal direction. A region surrounded by the scan lines 10 and the video signal lines 20 is configured as the pixel part and the pixel electrode 112 is present in the region. The pixel part has a size of, for example, not more than about 30 μm in the horizontal direction and not more than about 120 μm in the vertical direction. The liquid crystal display device according to the embodiment of the present invention is particularly beneficial to such a high definition screen as mentioned above. Although in the example in FIG. 2, the video signal lines 20 are linearly extended in the vertical direction, there are also cases where the video signal lines 20 are extended in the vertical direction while bending modeling after bending of the later described pixel electrode 112.

In the example in FIG. 2, the video signal line 20 and the semiconductor layer 103 are connected together through the through-hole 140. The semiconductor layer 103 is extended under the video signal line 20, passes under the scan line 10, passes again under the scan line 10 by being bent and is connected with the contact electrode 107 illustrated in FIG. 1 via the through-hole 120. The scan line 120 serves as a gate electrode of the TFT and in the example in FIG. 2, the two TFTs are serially formed ranging from the video signal line 20 to the pixel electrode 112. A set of the two TFTs which are serially formed as described above is also called a double-gate TFT. The contact electrode 107 and the pixel electrode 112 are connected together via the through-hole 130 formed in the organic passivation film 109.

The pixel electrode 112 has a shape in which a slit 1121 is formed and which is long in the vertical direction (the direction that the video signal lines 20 are extended). Since in the example in FIG. 2, the two slits 1121 are present in the pixel electrode 112, the pixel electrode 112 is configured by three linear (stripe-shaped) electrodes. Incidentally, the present invention is also applicable to a case where the pixel electrode 112 is configured by one to two linear electrode(s) and/or a case where the pixel electrode 112 is configured by four or more linear electrodes.

An orientation axis AL of the orientation film 113 is directed in the vertical direction (the direction that the video signal lines 20 are extended) in FIG. 2. The pixel electrode 112 includes a bent part 1122 on a vertical central part thereof. Although the upper half and the lower half of the pixel electrode 112 are inclined at an angle of η relative to the orientation axis AL, the upper side (the upper half) and the lower side (the lower half) are inclined in opposite directions. The angle η is about 5° to about 15°. The pixel electrode 112 is inclined at the angle of η relative to the orientation axis AL in order to rotate the liquid crystal molecules 301 in a fixed direction when the voltage has been applied to the pixel electrode 112.

Accordingly, in the example in FIG. 2, when the voltage has been applied to the pixel electrode 112, the liquid crystal molecules which are present in the upper half and the lower half of the pixel part are rotated in opposite directions. Thereby, it becomes possible to make viewing angle characteristics or azimuth characteristics more uniform. The pixel configuration illustrated in FIG. 2 is called a dual-domain system because two domains are present in one pixel.

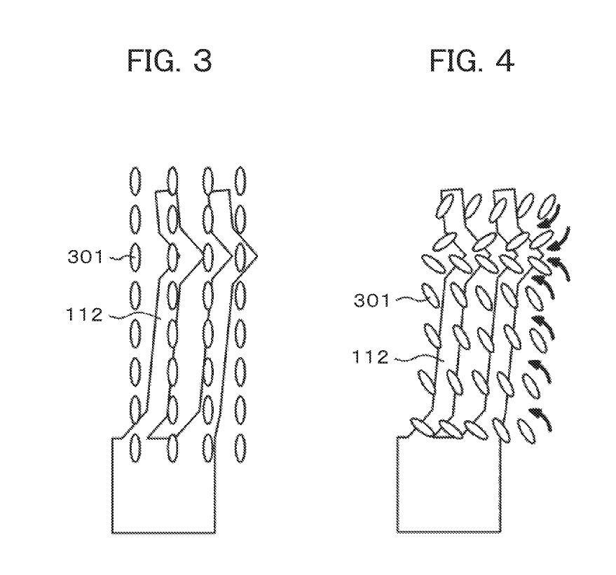

FIG. 3 is a schematic diagram illustrating one example of a general orientation state of the liquid crystal molecules 301 when no voltage is applied to the pixel electrode 112. FIG. 4 is a schematic diagram illustrating one example of an orientation state of the liquid crystal molecules 301 when the voltage has been applied to the pixel electrode 112. In the example in FIG. 4, the liquid crystal molecules are rotated in the opposite directions above and under the bent part 1122 of the pixel electrode 112. Thereby, the viewing angle characteristics or the azimuth characteristics are made uniform.

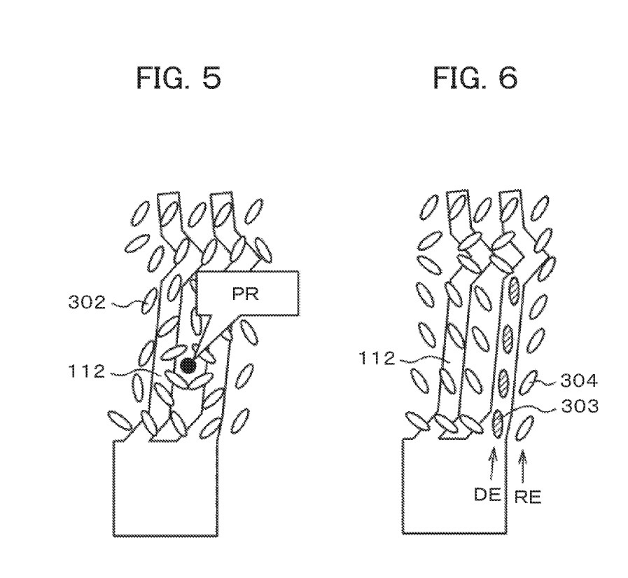

In recent years, a liquid crystal display device into which a touch panel configured to touch the counter substrate side of a liquid display panel with a finger and so forth is incorporated is widely used. When the liquid crystal display panel is touched with the finger and so forth, the liquid crystal layer corresponding to the touched part is depressed via the counter substrate and therefore the orientation of the liquid crystal molecules 301 is disturbed. FIG. 5 is a schematic diagram illustrating one example of disturbance of the orientation directions of the respective liquid crystal molecules 301 which would occur in such a case as mentioned above.

In the example in FIG. 5, assuming that a pressurizing point at which the counter substrate 200 is pressurized is designated by PR, the disturbance occurs in orientation as illustrated by liquid crystal molecules 302 centering on the pressurizing point PR. Consequently, the transmittance of the liquid crystal is made different from others at this part and the part becomes a region where display is abnormally made. Even when such a display abnormal region as mentioned above is generated, there would be no inconvenience as long as the liquid crystals 301 return to their normal states after the finger and so forth have been detached from that part, that is, after pressurization has been released.

However, since the liquid crystal has a viscosity, the orientation direction of the liquid crystal molecules in the upper half of the pixel part in FIG. 2 affects the orientation direction of the liquid crystal molecules in the lower half of the pixel part and such a phenomenon occurs that the orientation direction of the liquid crystal molecules in the lower half of the pixel part does not return to the original orientation direction and the liquid crystal molecules in the lower half of the pixel part are oriented in the orientation direction of the liquid crystal molecules in the upper half of the pixel part. FIG. 6 is a schematic diagram illustrating one example of the above-mentioned inconvenience.

Although FIG. 6 is a plan view illustrating one example of the lower half of the pixel electrode 112, the orientation direction of the liquid crystal molecule 301 located on the right-end outer side of the pixel electrode 112 is made the same as the orientation direction of the liquid crystal molecules on the upper side of the pixel electrode 112. Then, the orientation directions of the liquid crystal molecules are made different from one another among the part on the right-end outer side of the pixel electrode 112 and other parts on the lower side of the pixel electrode 112. That is, liquid crystal molecules located on the right-end outer side of the pixel electrode 112 are rotated in the reverse direction as designated by 304. A region where the liquid crystal molecules are rotated in the reverse direction is referred to as a reverse-rotation region RE.

Then, a part on the right-side stripe-shaped pixel electrode serves as a boundary along which the liquid crystal molecules are oriented in the opposite directions and the liquid crystal molecules in that part are in a state which is the same as that when the liquid crystal molecules are not rotated by voltage application. The liquid crystal molecules in this part are designated by 303. This part is referred to as so-called disclination DE. Presence of the disclination DE induces a reduction in transmittance of the pixel.

The embodiment of the present invention is configured such that a protruded part 30 and a recessed part 40 are formed on the pixel electrode 112 on the lower part of the pixel electrode 112, that is, in the vicinity of the through-hole 130 and a corner cut 50 is formed on the right lower side so as to apply the electric field which works so as to forcibly orient the liquid crystal molecules in the same direction as that of the liquid crystal molecules in other regions on the lower side of the pixel electrode 112 to the liquid crystal molecules 301 on the right-end outer side of the pixel electrode 112. In the example in FIG. 2, a dotted-line region indicates a region of the black matrix 202 which has been formed on the counter substrate 200. That is, the protruded part 30 and the recessed part 40 formed on the pixel electrode 112 are covered with the black matrix 202. Accordingly, in the general state, the protruded part 30 and the recessed part 40 of the pixel electrode 112 do not affect the transmittance of the liquid crystal display device.

Since the liquid crystal has the viscosity, the liquid crystal molecules 301 which have been forcibly arrayed in a predetermined direction owing to the presence of the protruded part 30 and the recessed part 40 of the pixel electrode 112 also affect other regions located along a right side face of the pixel electrode 112 and thereby the orientation of the liquid crystal molecules 301 is maintained in a normal state along the entire of a lower right end of the pixel electrode 112.

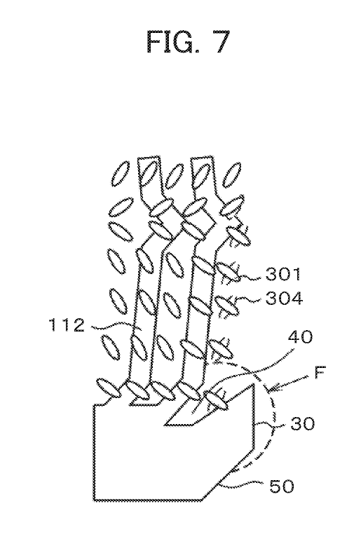

FIG. 7 is a schematic diagram illustrating one example of a situation which has been described above. In the example in FIG. 7, the protruded part 30 and the recessed part 40 are present on the lower side (the side which is close to the contact electrode 107 with the bending point of the pixel electrode 112 being set as a reference) of the pixel electrode 112 and the corner cut 50 is formed in a right lower part of the pixel electrode 112. In the example in FIG. 7, a region where a force acting so as to forcibly orient the liquid crystal molecules 301 in the same direction as that of the liquid crystal molecules in other regions on the lower side of the pixel electrode 112 is generated is designated by a dotted line F. In the example in FIG. 7, dotted-line liquid crystal molecules 304 indicate molecules which have been oriented in the orientation direction in an existing example when pressurization has been released. In contrast, in the embodiment of the present invention, the liquid crystal molecules 301 are oriented in the same direction as that of the liquid crystal molecules in other regions on the lower side of the pixel electrode 112 owing to the presence of the region F formed by the protruded part 30, the recessed part 40 and/or the corner cut 50 and generation of the disclination DE is suppressed.

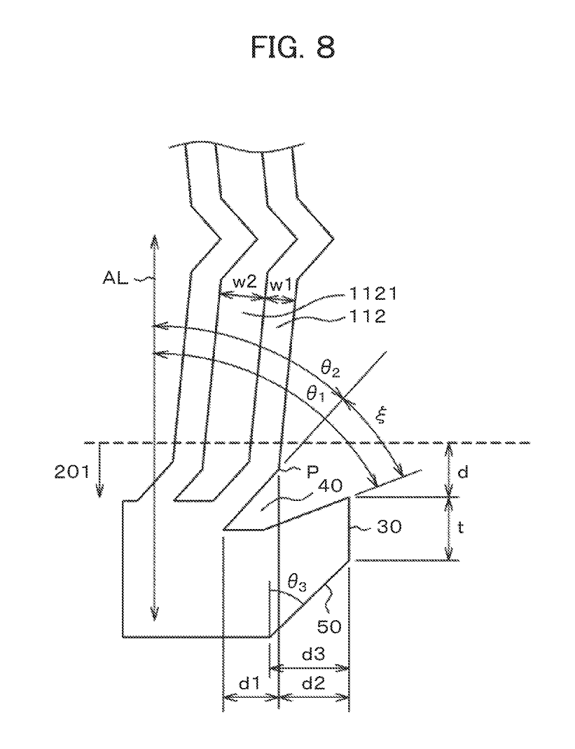

FIG. 8 is an enlarged diagram illustrating one example of the shape of the pixel electrode 112 according to the embodiment of the present invention. In the example in FIG. 8, a width w1 of a stripe part of the pixel electrode 112 is, for example, about 3.5 μm and a width w2 of the slit 1121 in the pixel electrode 112 is, for example, about 3.9 μm. In the example in FIG. 8, after the pressing pressure (pressurization) has been released, the liquid crystal molecules 301 are maintained in the normal orientation direction owing to the presence of the protruded part 30, the recessed part 40 and the corner cut 50. Incidentally, the recessed part 40, the protruded part 30 and the corner cut 50 are covered with the black matrix 202 formed on the counter substrate 200.

In the example in FIG. 8, the stripe-shaped pixel electrode 112 is bent at a point P, the recessed part is formed starting from the bent part (the bending point) P and a distance d1 measured from the bending point P to the innermost of the recessed part 40 is defined as a depth of the recessed part 40. When the pixel electrode 112 gently curves and therefore the bending point P is not clearly defined, a tangential intersecting point of a side of the pixel electrode 112 and an upper side of the recessed part 40 is defined as the bending point P.

A length d2 of the protruded part 30 in the horizontal direction in the drawing (the direction that the scan lines 10 are extended) is defined with a horizontal-direction position of the bending point P being set as a reference. The length d2 is larger than zero and may be optionally selected so as to obtain the advantageous effect of the present invention. However, it is preferable not to extend the length d2 up to the next pixel. That is, the protruded part 30 may be also formed so as to overlap the video signal line 20 in planar view. In addition, a width t of the tip of the protruded part 30 may be at least zero. A value which is at least a minimum working size, for example, at least about 2.5 μm may be ensured as a width d3 of the corner out 50 in the horizontal direction.

In the example in FIG. 8, angles of an upper side of the protruded part 30, the upper side of the recessed part 40 and the corner cut 50 relative to the orientation axis AL have a great effect on the orientation of the liquid crystal molecules 301. Here, the angle between the upper side of the protruded part 30 and the orientation axis AL is defined as θ1, the angle between the upper side of the recessed part 40 and the orientation axis AL is defined as θ2 and the angle between the corner cut 50 and the orientation axis AL is defined as θ3.

The advantageous effect of the present invention is obtained when the angle θ1 is not more than about 90°. On the other hand, when the angle θ1 is too small, it becomes difficult to cover the protruded part 30 with the black matrix 202. Therefore, it is desirable that the angle θ1 be at least about 45°. Accordingly, the angle θ1 is in a range from not more than about 90° to at least about 45°, more preferably, from at least about 45° to not more than about 85° and further more preferably, from at least about 45° to not more than about 80°.

Since it is desirable to suppress generation of the disclination on the right end of the pixel electrode 112 and ends of the pixel electrode 112 in other regions, it is desirable to determine the angle θ2 depending on the conditions for suppressing generation of the disclination. Accordingly, the angle θ2 becomes smaller than the angle θ1 by an angle ξ.

Although it is desirable that the angle θ3 of the corner cut 50 relative to the orientation axis AL be not more than about 90°, it is also possible to set the angle θ3 to be not more than about 45° in a range of angles that the length d2 of the protruded part 30 in the horizontal direction is ensured. However, the most general angle θ3 is about 45° from the viewpoint of a relation between the advantageous effect of the present invention and a layout of the device used.

As illustrated in FIG. 7, it is possible to implement the liquid crystal display device which is suppressed in generation of the disclination and is high in transmittance by using the pixel electrode 112 which is configured as mentioned above. In addition, it is also possible to obtain the advantageous effect of the present invention to some extent simply by forming the recessed part 40 and the protruded part 30 with no provision of the corner cut 50. However, it is possible to exhibit the advantageous effect of the present invention more efficiently by providing the corner out 50 in addition to the recessed part 40 and the protruded part 30.

In the foregoing, although description has been made on the assumption that the bent part of the pixel electrode is oriented in the direction that the scan lines are extended as illustrated in FIG. 2, the present invention is also applicable to a case where the bent part of the pixel electrode is oriented in a direction opposite to that illustrated in FIG. 2, that is, in the direction opposite to the direction that the scan lines are extended. In this case, the recessed part, the protruded part and the corner cut are formed line-symmetrically relative to the arrangement in FIG. 2 and so forth.

In addition, in the foregoing, although a case where a dielectric anisotropy of the liquid crystal is positive, that is, a case where a positive-type liquid crystal has been used has been described, the present invention is also applicable to a case where the dielectric anisotropy of the liquid crystal is negative, that is, a case where a negative-type liquid crystal is used. In this case, the direction of the initial orientation will have an angle of about 90° relative to the direction illustrated in FIG. 2. In addition, the color filters, the black matrix and so forth may be provided on the TFT substrate. In addition, although in the above-mentioned embodiment, the pixel electrode is installed between the common electrode and the liquid crystal layer, it is also possible to apply the present invention even to a configuration that the common electrode is installed between the pixel electrode and the liquid crystal layer and the slit is formed in the common electrode within a range not deviating from the gist of the invention of the present application.

What is claimed is:

1. A liquid crystal display device, comprising:
a TFT substrate including scan lines which are extended in a first direction and are arrayed in a second direction, video signal lines, a TFT, and a pixel electrode formed in a region surrounded by the scan lines and the video signal lines;
a counter substrate; and
a liquid crystal layer between the TFT substrate and the counter substrate, wherein
the pixel electrode is extended in the second direction and includes a first side face on the side of the first direction,
the pixel electrode includes a first region which connects to the TFT, a second region which is inclined at an angle η relative to the second direction, and the third region which is inclined at an angle −η relative to the second direction,
the second region is bent in a direction opposite to the first direction in the vicinity of the first region to form a recessed part in the first side surface of the pixel electrode,
the recessed part includes an upper side and a lower side,
a protruded part which is extended in the first direction is included in the first region in the second direction relative to the recessed part and the lower side of the recessed part forms part of an upper side of the protruded part,
an angle θ1 of the upper side of the protruded part relative to the second direction is not more than about 90° and at least about 45°, and
an angle θ2 of the upper side of the recessed part relative to the second direction is not more than the angle θ1.

2. The liquid crystal display device according to claim 1, wherein
the lower side of the protruded part includes a corner cut and an angle θ3 of the corner cut relative to the second direction is not more than the angle θ1.

3. The liquid crystal display device according to claim 1 wherein
the counter substrate includes a black matrix and the protruded part is covered with the black matrix in planar view.

4. The liquid crystal display device according to claim 1, wherein
the protruded part is extended above the video signal line in planar view.

5. The liquid crystal display device according to claim 1, wherein
an orientation film is formed on the liquid crystal layer side of each of the TFT substrate and the counter substrate and an orientation axis of the orientation film is oriented in the second direction.

6. The liquid crystal display device according to claim 1, wherein
the liquid crystal of the liquid crystal layer is a positive-type liquid crystal.

7. The liquid crystal display device according to claim 1, wherein
the angle θ1 of the upper side of the protruded part relative to the second direction is at least about 45° and not more than about 85°.

8. The liquid crystal display device according to claim 2, wherein
the angle θ1 of the upper side of the protruded part relative to the second direction is at least about 45° and not more than about 85°.

9. The liquid crystal display device according to claim 3, wherein
the angle θ1 of the upper side of the protruded part relative to the second direction is at least about 45° and not more than about 85°.

10. The liquid crystal display device according to claim 4, wherein
the angle θ1 of the upper side of the protruded part relative to the second direction is at least about 45° and not more than about 85°.

11. The liquid crystal display device according to claim 1, wherein
the angle θ1 of the upper side of the protruded part relative to the second direction is at least about 45° and not more than about 80°.

12. The liquid crystal display device according to claim 2, wherein
the angle θ1 of the upper side of the protruded part relative to the second direction is at least about 45° and not more than about 80°.

13. The liquid crystal display device according to claim 3, wherein
the angle θ1 of the upper side of the protruded part relative to the second direction is at least about 45° and not more than about 80°.

14. The liquid crystal display device according to claim 4, wherein
the angle θ1 of the upper side of the protruded part relative to the second direction is at least about 45° and not more than about 80°.
